(19) United States
(12) Patent Application Publication
(10) Pub. No.: US 2025/0292775 A1
(43) Pub. Date: Sep. 18, 2025

(54) VOICE RECOGNITION DEVICE, VOICE RECOGNITION METHOD, AND STORAGE MEDIUM

(71) Applicant: HONDA MOTOR CO., LTD., Tokyo (JP)

(72) Inventors: Shakeel Muhammad, Wako-shi (JP); Yui Sudo, Wako-shi (JP)

(21) Appl. No.: 19/069,469

(22) Filed: Mar. 4, 2025

(30) Foreign Application Priority Data
Mar. 13, 2024 (JP) 2024-038898

(51) Int. Cl. G10L 15/30; G10L 15/02; G10L 15/16

(52) U.S. Cl. CPC G10L 15/30; G10L 15/02; G10L 15/16

(57) ABSTRACT

A voice recognition device includes an acquisition unit which acquires a frame per unit time of a voice stream, a streaming feature generation unit which generates a first feature from the frame using a streaming encoder, a streaming character generation unit which generates a first character from the first feature using a streaming decoder, a non-streaming feature generation unit which generates a second feature sequence from a first feature sequence obtained by joining the first feature of each of the plurality of frames using a non-streaming encoder, a streaming character generation unit which generates a second character string from the second feature sequence using a plurality of non-streaming decoders, and a learning unit which performs Knowledge Distillation between the streaming encoder and the non-streaming encoder on the basis of the first feature sequence and the second feature sequence.

### CROSS-REFERENCE TO RELATED APPLICATION

This application is based upon and claims the benefit of priority from Japanese Patent Application No. 2024-038898, filed Mar. 13, 2024, the entire content of which is incorporated herein by reference.

### BACKGROUND

### Field of the Invention

The present invention relates to a voice recognition device, a voice recognition method, and a storage medium.

### Description of Related Art

End-to-end (E2E) automatic speech recognition (ASR) operates in two modes such as streaming and non-streaming. It is known that streaming ASR and non-streaming ASR each have advantages and disadvantages. Although streaming ASR can process voice frames in real time as they are received, the accuracy of voice recognition tends to be lower than that of non-streaming ASR. On the other hand, non-streaming ASR cannot process voice frames in real time and requires waiting for the entire voice speech, but tends to have higher speech recognition accuracy than streaming ASR.

### SUMMARY

Here, in the technique in the related art, there is room for improvement in terms of improving the accuracy of speech recognition by combining streaming ASR and non-streaming ASR.

The present invention was made in consideration of the above circumstances, and one of objects of the present invention is to provide a voice recognition device, a voice recognition method, and a storage medium which can further improve the accuracy of voice recognition.

A voice recognition device, a voice recognition method, and a storage medium according to the present invention have the following configurations.
(1) A first example of the present invention is a voice recognition device including an acquisition unit which acquires a frame per unit time of a voice stream, a streaming feature generation unit which generates a first feature from the frame using a streaming encoder, a streaming character generation unit which generates a first character from the first feature using a streaming decoder, a non-streaming feature generation unit which generates a second feature sequence from a first feature sequence obtained by joining the first feature of each of the plurality of frames using a non-streaming encoder, a streaming character generation unit which generates a second character string from the second feature sequence using a plurality of non-streaming decoder, and a learning unit which performs Knowledge Distillation between the streaming encoder and the non-streaming encoder on the basis of the first feature sequence and the second feature sequence.
(2) According to a second example of the present invention, in the first example, the learning unit may perform the Knowledge Distillation between the streaming encoder and the non-streaming encoder so that the first feature sequence is similar to the second feature sequence.
(3) According to a third example of the present invention, in the first or second example, the learning unit may further perform the Knowledge Distillation between the streaming decoder and the plurality of non-streaming decoders on the basis of a likelihood of a first character string in which the first characters generated from each of the plurality of first features are arranged in chronological order and a likelihood of the second character string generated from the second feature sequence.
(4) According to a fourth example of the present invention, in the third example, the streaming decoder may include at least a predictor configured to predict the first character, the plurality of non-streaming decoders may include at least an attention decoder that is a decoder including an attention mechanism, and the learning unit may perform the Knowledge Distillation between the predictor and the attention decoder so that a likelihood of the first character string in which the first character predicted using the predictor is arranged in chronological order is similar to a likelihood of the second character string output using the attention decoder.
(5) A fifth example of the present invention is a voice recognition method including acquiring a frame per unit time of a voice stream, generating a first feature from the frame using a streaming encoder, generating a first character from the first feature using a streaming decoder, generating a second feature sequence from a first feature sequence obtained by joining the first feature of each of the plurality of frames using a non-streaming encoder, generating a second character string from the second feature sequence using a plurality of non-streaming decoder, and performing Knowledge Distillation between the streaming encoder and the non-streaming encoder on the basis of the first feature sequence and the second feature sequence.
(6) A sixth example of the present invention is a non-transient storage medium having a program (instructions) stored therein, the program (computer-readable instructions) causing a computer to execute acquiring a frame per unit time of a voice stream, generating a first feature from the frame using a streaming encoder, generating a first character from the first feature using a streaming decoder, generating a second feature sequence from a first feature sequence obtained by joining the first feature of each of the plurality of frames using a non-streaming encoder, generating a second character string from the second feature sequence using a plurality of non-streaming decoders, and performing Knowledge Distillation between the streaming encoder and the non-streaming encoder on the basis of the first feature sequence and the second feature sequence.

According to the above examples, it is possible to further improve the accuracy of voice recognition.

### BRIEF DESCRIPTION OF THE DRAWINGS

FIG. 1 is a constitution diagram of a voice recognition device according to an embodiment.

FIG. 2 is a flowchart for describing a flow of a series of processes in a processing unit of an embodiment.

FIG. 3 is a diagram for explaining constitutions of a streaming ASR module and a non-streaming ASR module and a method of Knowledge Distillation thereof.

FIG. 4 is a diagram showing an absolute value and a relative value of a character error rate for each method at the time of using a Japanese corpus.

FIG. 5 is a diagram showing change in word error rate with respect to a block size for each of a method in an embodiment and a comparative method.

FIG. 6 is a diagram showing change in word error rate with respect to a block size for each of a method in an embodiment and a comparative method.

### DESCRIPTION OF EMBODIMENTS

Embodiments of a voice recognition device, a voice recognition method, and a storage medium of the present invention will be described below with reference to the drawings.

### [Constitution of Voice Recognition Device]

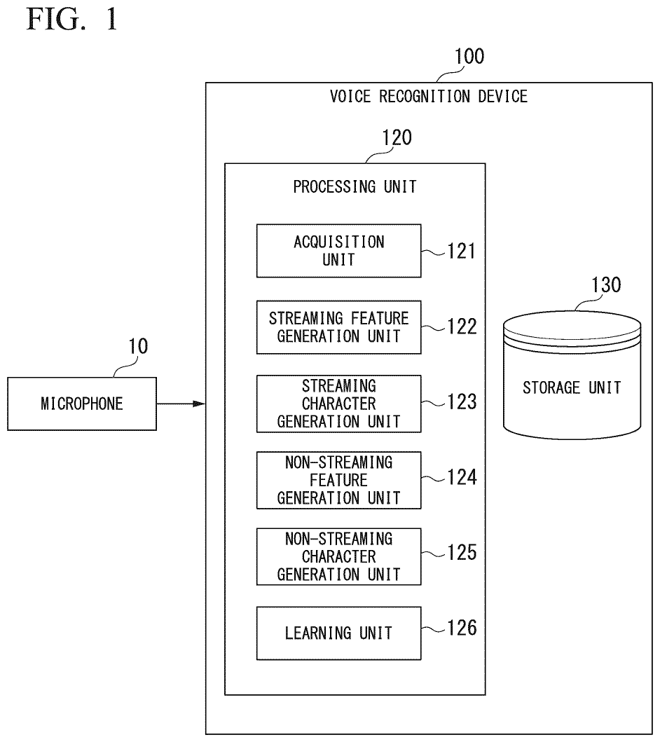

FIG. 1 is a constitution diagram of a voice recognition device 100 according to an embodiment. The voice recognition device 100 may be a single device or may be a system in which a plurality of devices connected over a network NW such as a Local Area Network (LAN) or a Wide Area Network (WAN) operate in cooperation with each other. That is to say, the voice recognition device 100 may be implemented through a plurality of computers (processors) included in a distributed computing system or a cloud computing system.

The voice recognition device 100 includes, for example, a processing unit 120 and a storage unit 130. The processing unit 120 includes, for example, an acquisition unit 121, a streaming feature generation unit 122, a streaming character generation unit 123, a non-streaming feature generation unit 124, a non-streaming character generation unit 125, and a learning unit 126.

The constituent elements of the processing unit 120 are realized using, for example, a processor such as a Central Processing Unit (CPU) or a Graphics Processing Unit (GPU) executing a program stored in the storage unit 130. Furthermore, the constituent elements of the processing unit 120 may be realized using hardware such as a Large Scale Integration (LSI), an Application Specific Integrated Circuit (ASIC), a Field-Programmable Gate Array (FPGA), or a System On Chip (SOC) or may be realized through a cooperation of software and hardware.

The processing unit 120 uses a streaming ASR module (hereinafter also referred to as a “streaming ASR model”) and a non-streaming ASR module (hereinafter also referred to as a “non-streaming ASR model”) to recognize a character string representing the details of a speech from voice data (hereinafter also referred to as a “voice stream”) of the speech. The speech described herein typically is a speech of a person (user), but is not limited to this and may also be an artificial speech through, for example, a robot, a machine, or a computer. That is to say, the speech may be a speech artificially produced through a voice combination technique.

The streaming ASR module includes a streaming encoder ENC1 and a streaming decoder DEC1. The non-streaming ASR module includes a non-streaming encoder ENC2 and a plurality of non-streaming decoders DEC2 of different types. These various encoders and decoders will be described in detail below.

The storage unit 130 is realized using, for example, a hard disk drive (HDD), a flash memory, an electrically erasable programmable read only memory (EEPROM), a read only memory (ROM), a random access memory (RAM), or the like. The storage unit 130 has firmware, application programs, and the like stored therein. Moreover, the storage unit 130 has programs, algorithms, or architectures which define a streaming ASR module or a non-streaming ASR module stored therein.

### [Processing Flow]

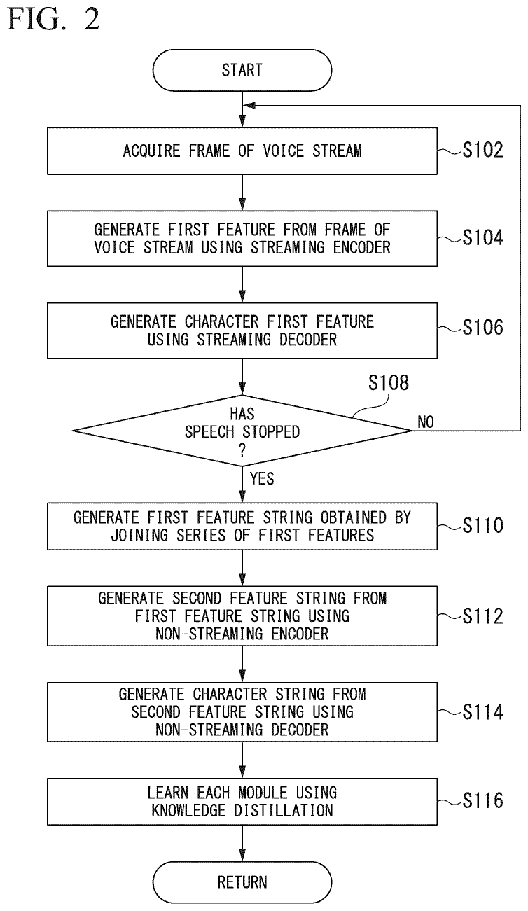

The details of a process of each of the constituent elements in the processing unit 120 will be explained below with reference to a flowchart. FIG. 2 is a flowchart for describing a flow of a series of processes performed by the processing unit 120 according to an embodiment. The process of this flowchart may be repeatedly performed at a predetermined cycle.

First, the acquisition unit 121 acquires a frame (hereinafter referred also to as a “block”) of a voice stream from a microphone 10 (Step S102). The frame is a portion or a segment of a voice stream which is separated per unit time.

The streaming feature generation unit 122 generates a first feature h from frames in a voice stream X using a streaming encoder ENC1 included in the streaming ASR module (Step S104).

Subsequently, the streaming character generation unit 123 generates characters from the first feature h using a streaming decoder DEC1 included in the streaming ASR module (Step S106).

Subsequently, the acquisition unit 121 determines whether a speech has ended (Step S108). For example, the acquisition unit 121 may subject a voice stream to Voice Activity Detection (VOD) and determine whether the speech has ended on the basis of the result of the Voice Activity Detection.

When a speech is continuing, the acquisition unit 121 acquires a new frame in the voice stream from the microphone 10. In response to this, the streaming feature generation unit 122 generates a new first feature h from the new frame and the streaming character generation unit 123 generates a new character from the new first feature h. In this way, characters are generated for each frame using the streaming ASR module frames until the speech stops. That is to say, a series of character strings (that is, words, sentences, or the like) until the speech stops is generated. A character string having the characters generated from each of the plurality of first features h arranged in chronological order is an example of a “first character string.”

On the other hand, when the speech continues, the non-streaming feature generation unit 124 generates a first feature sequence Hₛₜ having the first features h of each of the plurality of frames acquired until the speech stops arranged in chronological order (Step S110).

Subsequently, the non-streaming feature generation unit 124 generates a second feature sequence Hₜₑ from the first feature sequence Hₛₜ using the non-streaming encoder ENC2 included in the non-streaming ASR module (Step S112). For example, the first feature sequence Hₛₜ and the second feature sequence Hₜₑ may be represented using a matrix or a vector and the number of dimensions thereof is the same.

Subsequently, the non-streaming character generation unit 125 generates a character string from the second feature sequence Hₜₑ using at least one of a plurality of non-streaming decoders DEC2 included in the non-streaming ASR module (Step S114). The character string generated from the second feature sequence Hₜₑ is an example of a “second character string.”

Subsequently, the learning unit 126 learns the non-streaming ASR module and the streaming ASR module using Knowledge Distillation (Step S116).

The Knowledge Distillation generally refers to a process of transmitting knowledge from a large-scale model to a small-scale model. In this embodiment, as the Knowledge Distillation, when the non-streaming ASR module is assumed as a student and the streaming ASR module is assumed as a teacher, knowledge is transmitted from the non-streaming ASR module that is a student to the streaming ASR module that is a teacher. Specifically, the non-streaming ASR module and the streaming ASR module are optimized so that an output of the non-streaming ASR module that is a student is similar to an output of the streaming ASR module that is a teacher. Such Knowledge Distillation which focuses on similarity is also particularly called similarity preserving Knowledge Distillation (sp-KD).

### [Process of Knowledge Distillation]

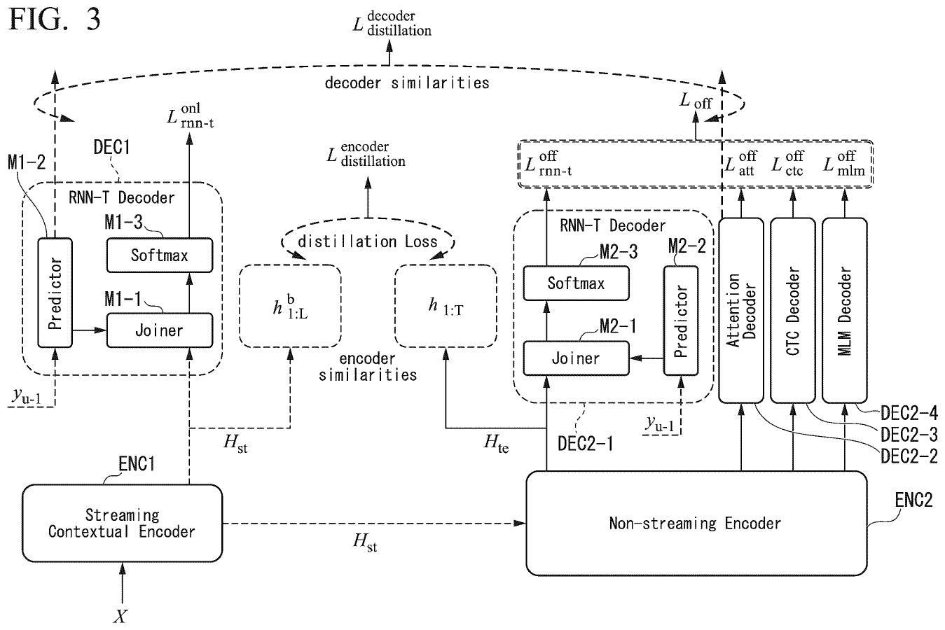

A process of Knowledge Distillation is explained in detail below. FIG. 3 is a diagram for explaining constitutions of the streaming ASR module and the non-streaming ASR module and a method of knowledge distillation therefor.

As described above, the streaming ASR module includes the streaming encoder ENC1 and the streaming decoder DEC1.

The streaming encoder ENC1 may adopt, for example, an encoder having M encoder layers stacked therein as described in References 1 to 4. By adopting such an encoder, it is possible to efficiently process frames of a voice stream.
Reference 1: Emiru Tsunoo, Yosuke Kashiwagi, Toshiyuki Kumakura, Shinji Watanabe, “Transformer ASR with Contextual Block Processing,” in Proc. ASRU, 2019, pp. 427-433.
Reference 2: Tianzi Wang, Yuya Fujita, Xuankai Chang, Shinji Watanabe, “Streaming End-to-End ASR based on Blockwise Non-Autoregressive Models,” in Proc. Interspeech, 2021.
Reference 3: Niko Moritz, Takaaki Hori, Jonathan Le Roux, “Streaming automatic speech recognition with the transformer model,” in Proc. ICASSP, 2020.
Reference 4: Yangyang Shi, Yongqiang Wang, Chunyang Wu, Ching-Feng Yeh, Julian Chan, Frank Zhang, Duc Le, Mike Seltzer, “Emformer: Efficient Memory Transformer Based Acoustic Model For Low Latency Streaming Speech Recognition,” in Proc. ICASSP, 2021.

The streaming decoder DEC1 is connected to a bus of the streaming encoder ENC1. The streaming decoder DEC1 may be, for example, a Recurrent Neural Network Transducer (RNN-T)-based decoder as described in Reference 5. Hereinafter, the RNN-T-based decoder will be particularly referred to as an “RNN-T decoder.”
Reference 5: Alex Graves, “Sequence Transduction with Recurrent Neural Networks,” in Proc. ICML, 2012.

The RNN-T decoder includes, for example, a joiner M1-1, a predictor M1-2, and a unit M1-3 whose activation function is a softmax function.

The joiner M1-1 may be implemented, for example, using a feedforward network. The joiner M1-1 receives, as inputs, the first feature h converted from a frame using the streaming encoder ENC1 and the first feature predicted using the predictor M1-2. The joiner M1-1 joins the two input first features and outputs a vector in which these first features are joined to the unit M1-3 of the softmax function.

The predictor M1-2 may be implemented by an RNN including a Long Short-Term Memory (LSTM). An immediately-previous character yᵤ₋₁ output using the unit M1-3 is fed back to the predictor M1-2. The predictor M1-2 predicts the next first feature on the basis of the first feature h so far and the immediately-previous character yᵤ₋₁. The unit M1-3 converts each component of the vector output using the joiner M1-1 into a likelihood and outputs it. Each of the components corresponds to a character and a character corresponding to a component having the highest likelihood is determined as a character corresponding to a frame input to the streaming decoder DEC1.

Also, as described above, the non-streaming ASR module includes a non-streaming encoder ENC2 and a plurality of non-streaming decoders DEC2 of different types.

The non-streaming encoder ENC2 is connected in series to the streaming encoder ENC1. The non-streaming encoder ENC2 may adopt, for example, an encoder having N encoder layers stacked therein as described in Reference 6.
Reference 6: Anmol Gulati, James Qin, Chung-Cheng Chiu, Niki Parmar, Yu Zhang, Jiahui Yu, Wei Han, Shibo Wang, Zhengdong Zhang, Yonghui Wu, Ruoming Pang, “Conformer: Convolution-augmented Transformer for Speech Recognition,” in Proc. Interspeech, 2020, pp. 5036-5040.

Each of the plurality of non-streaming decoders DEC2 is connected to a bus of the non-streaming encoder ENC2. The plurality of non-streaming decoders DEC2 may include, for example, an RNN-T decoder DEC2-1, an attention decoder DEC2-2, a Connectionist Temporal Classification (CTC) decoder DEC2-3, and a Masked Language Model (MLM) decoder DEC2-4.

As described above, the RNN-T decoder DEC2-1 is an RNN-T-based decoder. The RNN-T decoder DEC2-1 includes, for example, a joiner M2-1, a predictor M2-2, and a unit M2-3 whose activation function is a softmax function.

The attention decoder DEC2-2 is an attention mechanism-based decoder as described in Reference 7.
Reference 7: Yui Sudo, Muhammad Shakeel, Brian Yan, Jiatong Shi, Shinji Watanabe, “4D ASR: Joint modeling of CTC, Attention, Transducer, and Mask-Predict decoders,” ArXiv, 2022.

The CTC decoder DEC2-3 is a CTC-based decoder as described in Reference 7.

The MLM decoder DEC2-4 is an MLM-based decoder as described in Reference 7.

The streaming feature generation unit 122 inputs frames of the voice stream X to the streaming encoder ENC1. The streaming encoder ENC1 outputs the first feature h in response to a frame being input. In other words, the streaming encoder ENC1 converts a frame into the first feature h by embedding the frame in a certain feature space (hereinafter referred also to as a “latent space”).

The streaming character generation unit 123 inputs the first feature h converted from each frame to the streaming decoder DEC1. In response to the first feature h being input, the streaming decoder DEC1 outputs a character y with a likelihood. In other words, the streaming decoder DEC1 converts the first feature h into a character y by embedding the first feature h in a certain feature space.

The non-streaming feature generation unit 124 generates a first feature sequence Hₛₜ obtained by arranging the first features h of each of the plurality of frames acquired until the speech stops in chronological order and inputs this first feature sequence Hₛₜ to the non-streaming encoder ENC2. The non-streaming encoder ENC2 outputs a second feature sequence Hₜₑ in response to a first feature sequence Hₛₜ being input. In other words, the non-streaming encoder ENC2 converts the first feature sequence Hₛₜ into the second feature sequence Hₜₑ by embedding the first feature sequence Hₛₜ into a certain feature space.

The non-streaming character generation unit 125 selects at least one decoder from among the RNN-T decoder DEC2-1, the attention decoder DEC2-2, the CTC decoder DEC2-3, and the MLM decoder DEC2-4 and inputs the second feature sequence Hₜₑ to the selected decoder.

For example, the non-streaming character generation unit 125 may select a decoder in accordance with an application and a computer resource in which ASR is used.

Each of the RNN-T decoder DEC2-1, the attention decoder DEC2-2, the CTC decoder DEC2-3, and the MLM decoder DEC2-4 outputs a character string Y with a likelihood in response to the second feature sequence Hₜₑ being input. In other words, these four decoders DEC2-1 to 2-4 convert each second feature included in the second feature sequence Hₜₑ into a character y by embedding the second feature sequence Hₜₑ into a certain feature space. Thus, a character string Y which includes the same number of characters y as each second feature included in the second feature sequence Hₜₑ is generated.

Also, the non-streaming character generation unit 125 may select a plurality of decoders from among the RNN-T decoder DEC2-1, the attention decoder DEC2-2, the CTC decoder DEC2-3, and the MLM decoder DEC2-4 and input the second feature sequence Hₜₑ to the plurality of decoders. For example, the non-streaming character generation unit 125 may input the second feature sequence Hₜₑ to the RNN-T decoder DEC2-1, the attention decoder DEC2-2, and the CTC decoder DEC2-3 which have relatively high ASR accuracy among the four decoders. If each of these three decoders converts the second feature sequence Hₜₑ into a character string Y, the non-streaming character generation unit 125 may join the three character strings Y to generate a character string Y obtained by joining the most likely characters y.

The learning unit 126 calculates three types of losses and optimizes the streaming ASR module and the non-streaming ASR module on the basis of the three types of losses.

### [Online Loss]

First, the learning unit 126 calculates an online loss Lₒₙₗ and an offline loss L_{off}. The online loss Lonl is a loss relating to the likelihood of the output of the streaming ASR module side and is calculated, for example, through the following Expression (1).

$${ℒ}_{onl} = - {\sum }_{( X \to {H}_{st} , y )} log {P}_{onl} ( y \vert {H}_{st} ) . \qquad ( 1 )$$

As shown in Expression (1), the online loss Lₒₙₗ is represented using a negative logarithm likelihood Pₒₙₗ. The likelihood Pₒₙₗ is a likelihood of the character y per frame being output through the streaming decoder DEC1. That is to say, the online loss Lₒₙₗ is calculated by adding up the likelihoods Pₒₙₗ of the character y corresponding to all frames acquired until the speech stops.

### [Offline Loss]

The offline loss L_{off} is a loss relating to the likelihood of the output of the non-streaming ASR module side and is calculated, for example, through the following Expression (2).

$${ℒ}_{off} = {λ}_{ctc} {ℒ}_{ctc} + {λ}_{rnnt} {ℒ}_{rnnt} + {λ}_{att} {ℒ}_{att} + {λ}_{mlm} {ℒ}_{mlm} \qquad ( 2 )$$

As shown in Expression (2), an offline loss L_{off} is represented using a weighted sum of the losses of the RNN-T decoder DEC2-1, the attention decoder DEC2-2, the CTC decoder DEC2-3, and the MLM decoder DEC2-4. λ_{ctc}, λᵣₙₙₜ, λₐₜₜ, and λₘₗₘ are adjustable hyperparameters and may be determined through experiments or simulations.

A loss L_{ctc} of the CTC decoder DEC2-3 is calculated, for example, through the following Expression (3).

$${ℒ}_{ctc} = - {\sum }_{( {H}_{st} \to {H}_{te} , y )} log {P}_{ctc} ( y \vert {H}_{te} ) \qquad ( 3 )$$

As shown in Expression (3), a loss L_{ctc} of the CTC decoder DEC2-3 is represented through a negative logarithm likelihood P_{ctc}. A likelihood P_{ctc} is a likelihood of each character y included in the character string Y output using the CTC decoder DEC2-3. That is to say, the loss L_{ctc} of the CTC decoder DEC2-3 is calculated by adding up the likelihoods P_{ctc} of all characters y included in the character string Y output using the CTC decoder DEC2-3.

A loss Lᵣₙₙₜ of the RNN-T decoder DEC2-1 is calculated, for example, through Expression (4).

$${ℒ}_{rnnt} = - {\sum }_{( {H}_{st} \to {H}_{te} , y )} log {P}_{rnnt} ( y \vert {H}_{te} ) \qquad ( 4 )$$

As shown in Expression (4), a loss Lᵣₙₙₜ of the RNN-T decoder DEC2-1 is represented through the negative logarithm likelihood Pᵣₙₙₜ. The likelihood Pᵣₙₙₜ is a likelihood of each character y included in the character string Y output using the RNN-T decoder DEC2-1. That is to say, the loss Lᵣₙₙₜ of the RNN-T decoder DEC2-1 is calculated by adding up the likelihoods Pᵣₙₙₜ of all characters y included in the character string Y output using the RNN-T decoder DEC2-1.

A loss Lₐₜₜ of the attention decoder DEC2-2 is calculated, for example, through Expression (5).

$${ℒ}_{att} = - {\sum }_{( {H}_{st} \to {H}_{te} , y )} log {P}_{att} ( y \vert {H}_{te} ) . \qquad ( 5 )$$

As shown in Expression (5), a loss Lau of the attention decoder DEC2-2 is represented through a negative logarithm likelihood Pₐₜₜ. A likelihood Pₐₜₜ is a likelihood of each character y included in the character string Y output using the attention decoder DEC2-2. That is to say, the loss Lan of the attention decoder DEC2-2 is calculated by adding up the likelihoods Pₐₜₜ of all characters y included in the character string Y output using the attention decoder DEC2-2.

A loss Lₘₗₘ of the MLM decoders DEC2-4 is calculated, for example, through Expression (6).

$${ℒ}_{mlm} = - {\sum }_{( {H}_{st} \to {H}_{te} , y )} log {P}_{mlm} ( {y}_{mask} \vert {y}_{obs} , {H}_{te} ) . \qquad ( 6 )$$

As shown in Expression (6), a loss Lₘₗₘ of the MLM decoder DEC2-4 is represented through a negative logarithm likelihood Pₘₗₘ. yₘₐₛₖ is a masked character among a plurality of characters (tokens) included in the character string Y output using the MLM decoder DEC2-4. The masked characters yₘₐₛₖ are predicted from remaining unmasked characters (tokens) y_{obs}. A likelihood Pₘₗₘ is a likelihood of the masked character yₘₐₛₖ in the character string Y output using the MLM decoder DEC2-4. That is to say, the loss Lₘᵢₙ of the MLM decoder DEC2-4 is calculated by adding up the likelihood Pₘₗₘ of the masked character yₘₐₛₖ.

### [Knowledge Distillation Loss]

Subsequently, the learning unit 126 calculates a Knowledge Distillation loss L_{dist}. The knowledge distillation loss L_{dist} is calculated, for example, through Expression (7).

$${ℒ}_{dist} ( {G}_{te} , {G}_{st} ) = \frac{1}{{B}^{2}} {\sum }_{( l , {l}^{′} ) ∈ ϛ} {‖ {G}_{te}^{( l )} - {G}_{st}^{( {l}^{′} )} ‖}_{F}^{2} \qquad ( 7 )$$

Gₜₑ which is treated as a teacher represents a second feature sequence Hₜₑ output using the non-streaming encoder ENC2. Gₛₜ which is treated as a student represents a first feature sequence Hₛₜ which is a first feature h output using the streaming encoder ENC1 arranged in chronological order.

ζ adds a pair of (l,l′) layers which are similar to each other at the end of each of the streaming encoder ENC1 and the non-streaming encoder ENC2. In Expression (7), F is the Frobenius norm and calculates a mean element-wise squared difference between matrices Gₜₑ^{(l)} and Gₛₜ^{(l)} and B×B represents a size of the matrices Gₜₑ^{(l)} and Gₛₜ^{(l′)}.

The learning unit 126 calculates, as (Gₜₑ^{(l)}−Gₛₜ^{(l′)}), a difference between a first feature sequence Hₛₜ corresponding to the output of the streaming encoder ENC1 and a second feature sequence Hₜₑ corresponding to the output of the non-streaming encoder ENC2 and calculates a loss based on (Gte^{(l)}−Gst^{(l′)}) as the Knowledge Distillation loss L_{dist} between the encoders. The encoder of each ASR module is learned to minimize the Knowledge Distillation loss L_{dist} between the encoders. That is to say, the parameters of each of the encoders are optimized so that the first feature sequence Hₛₜ of a student is similar to the second feature sequence Hₜₑ of a teacher (hereinafter referred also to as a “target”).

Furthermore, the learning unit 126 may calculate a Knowledge Distillation loss between the decoders in addition to the Knowledge Distillation loss between the encoders. In this case, in Expression (7), Gₜₑ treated as a teacher represents a likelihood Pₐₜₜ of the character string Y output using the attention decoder DEC2-2 and Gₛₜ treated as a student represents a likelihood P_{prd} of the character string Y in which the character y output using the predictor M1-2 of the streaming decoder DEC1 is arranged in chronological order.

The learning unit 126 calculates, as (Gₜₑ^{(l)}−Gₛₜ^{(l′)}), a difference between a likelihood P_{prd} corresponding to the output of the predictor M1-2 of the streaming decoder DEC1 and a likelihood Pₐₜₜ corresponding to the output of attention decoder DEC2-2 and calculates a loss based on (Gₜₑ^{(l)}−Gₛₜ^{(l′)}) as a Knowledge Distillation loss L_{dist} between the decoders. The decoder and the encoder of each ASR module are learned to minimize a Knowledge Distillation loss L_{dist} between the decoders. That is to say, the parameters of the ASR module are optimized so that a likelihood P_{prd} of a student is similar to a likelihood Pₐₜₜ of a teacher (hereinafter referred also to as a “target”).

Finally, the learning unit 126 calculates a total loss Lₘₜₗ for multitasking by combining an online loss Lₒₙₗ, an offline loss L_{off}, and a Knowledge Distillation loss L_{dist}, as shown in Expression (9). This Knowledge Distillation loss L_{dist} may include a Knowledge Distillation loss L_{dist} between the encoders and a Knowledge Distillation loss L_{dist} between the decoders.

$${ℒ}_{mtl} = {λ}_{onl} {ℒ}_{onl} + {λ}_{off} {ℒ}_{off} + {λ}_{dist} {ℒ}_{dist} \qquad ( 8 )$$

λₒₙₗ, λ_{off}, and λ_{dist} are weighting coefficients. The learning unit 126 may calculate a total loss Lₘₜₗ as a weighted sum of the online loss Lₒₙₗ, the offline loss L_{off}, and the Knowledge Distillation loss L_{dist}.

Also, the learning unit 126 optimizes the parameters of the streaming ASR module and the non-streaming ASR module using a gradient method or the like so that the total loss Lₘₜₗ is reduced.

### [Comparison Results Between Method in Embodiment and Other Methods]

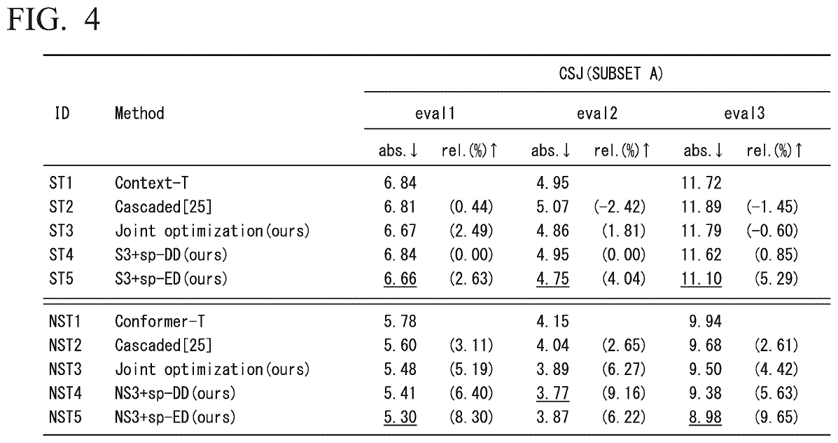

Comparison results between the method in the embodiment and other methods will be explained below. FIG. 4 shows an absolute value (abs.) and a relative value (rel.) of a character error rate (CER) for each method at the time of using the Japanese corpus. ST1 to ST5 represent CERs of the streaming ASR module of each of the methods and NST1 to NST5 represent CERs of the non-streaming ASR module of each of the methods.

ST1 and NST1 are methods in which the streaming ASR module and the non-streaming ASR module are not connected in series. In other words, ST1 and NST1 are techniques in which the output of the streaming encoder ENC1 is not processed using the non-streaming encoder ENC2.

ST2 and NST2 are methods for connecting the streaming ASR module and the non-streaming ASR module in series. Here, each of the ASR modules has one decoder.

ST3 and NST3 are methods for connecting the streaming ASR module and the non-streaming ASR module in series. There is one decoder for the streaming ASR module and four decoders for the non-streaming ASR module.

ST4 and NST4 are techniques in which the streaming ASR module having one decoder and the non-streaming ASR module having four decoders are connected in series and also the output of the attention decoder among the four decoders included in the non-streaming ASR module is subjected to Knowledge Distillation to a predictor of the decoder of the streaming ASR module.

ST5 and NST5 are a method in the embodiment and a method in which, in addition to the method of ST4 and NST4, Knowledge Distillation is further performed from the output of the encoder of the non-streaming ASR module to the encoder of the streaming ASR module.

As shown in FIG. 4, compared to a baseline ST1, all of ST2-5 have an improved CER. Particularly, ST5 of this method also significantly improves a CER in all Evaluation (eval.1) to Evaluation 3 (eval.3). The same applies to NST. That is to say, compared to a baseline NST1, all of NST2-5 have an improved CER. Particularly, NST5 of this method also significantly improves CER in all Evaluation 1 (eval.1) to Evaluation 3 (eval.3).

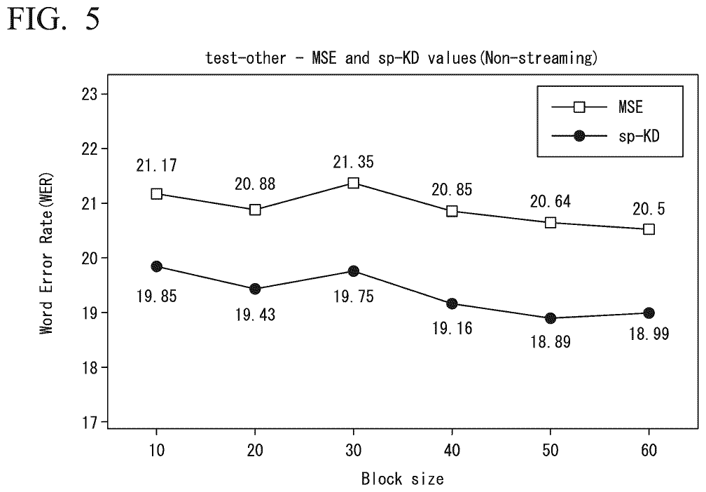

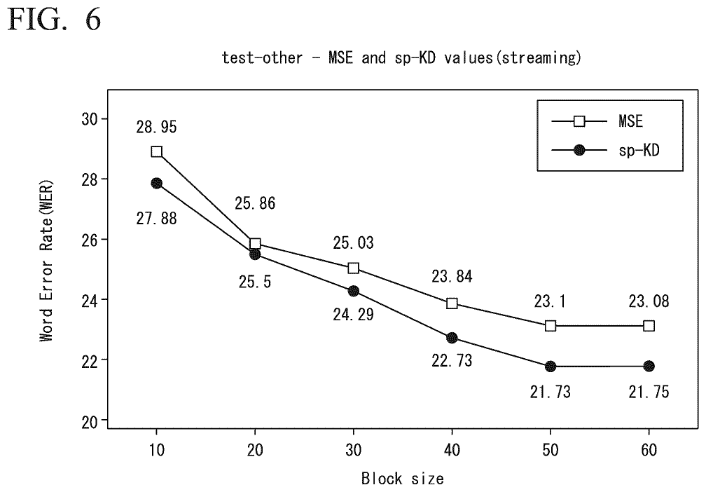

FIGS. 5 and 6 are diagrams showing changes in word error rate (WER) versus block size (frame size) for the method in the embodiment and a comparative method. FIG. 5 shows the evaluation results of the performance of the non-streaming ASR module and FIG. 6 shows the evaluation results of the performance of the streaming ASR module. As described above, sp-KD represents similarity preserving-based Knowledge Distillation, that is, the method in the embodiment. MSE represents a Mean Squared Error-based Knowledge Distillation method. In both the non-streaming ASR module and the streaming ASR module, the method in the embodiment has a significantly improved WER compared to the comparative method.

According to the embodiment described above, the processing unit 120 of the voice recognition device 100 acquires frames of a voice stream and generates the first feature h from the frames using the streaming encoder ENC1. The processing unit 120 uses the streaming decoder DEC1 to generate the character y from the first feature h. The processing unit 120 generates the first feature sequence Hₛₜ by joining the first feature h of each of a series of the plurality of frames acquired until the speech is segmented. The processing unit 120 generates the second feature sequence Hₜₑ from the first feature sequence Hₛₜ using the non-streaming encoder ENC2. The processing unit 120 generates the character string Y from the second feature sequence Hₜₑ using the plurality of non-streaming decoders DEC2. Furthermore, the processing unit 120 performs Knowledge Distillation between the streaming encoder ENC1 and the non-streaming encoder ENC2 on the basis of the first feature sequence Hₛₜ and the second feature sequence Hₜₑ. In other words, the processing unit 120 learns each of the encoders to minimize at least the Knowledge Distillation loss Laic between the decoders. As a result, the streaming ASR module and the non-streaming ASR module connected in series thereto can be optimized, thereby further improving the accuracy of voice recognition.

The above-described embodiment can be expressed as follows:

A voice recognition device including:
a storage medium which stores computer-readable instructions; and
a processor which is connected to the storage medium,
the processor executing the computer-readable instructions to:
acquire a frame per unit time of a voice stream,
generate a first feature from each of the frames using a streaming encoder,
generate a first character from the first feature using a streaming decoder,
generate a second feature sequence from a first feature sequence obtained by joining the first feature of each of the plurality of frames using a non-streaming encoder,
generate a second character string from the second feature sequence using a plurality of non-streaming decoders, and
perform Knowledge Distillation between the streaming encoder and the non-streaming encoders on the basis of the first feature sequence and the second feature sequence.

Although the embodiments for carrying out the present invention have been explained above using the embodiments, the present invention is not limited to these embodiments and various modifications and substitutions can be made without departing from the gist of the present invention.

What is claimed is:

1. A voice recognition device, comprising:
an acquisition unit which acquires a frame per unit time of a voice stream;
a streaming feature generation unit which generates a first feature from the frame using a streaming encoder;
a streaming character generation unit which generates a first character from the first feature using a streaming decoder;
a non-streaming feature generation unit which generates a second feature sequence from a first feature sequence obtained by joining the first feature of each of the plurality of frames using a non-streaming encoder;
a streaming character generation unit which generates a second character string from the second feature sequence using a plurality of non-streaming decoders; and
a learning unit which performs Knowledge Distillation between the streaming encoder and the non-streaming encoder on the basis of the first feature sequence and the second feature sequence.

2. The voice recognition device according to claim 1, wherein the learning unit performs the Knowledge Distillation between the streaming encoder and the non-streaming encoder so that the first feature sequence is similar to the second feature sequence.

3. The voice recognition device according to claim 1, wherein the learning unit further performs the Knowledge Distillation between the streaming decoder and the plurality of non-streaming decoders on the basis of a likelihood of a first character string in which the first characters generated from each of the plurality of first features are arranged in chronological order and a likelihood of the second character string generated from the second feature sequence.

4. The voice recognition device according to claim 3, wherein the streaming decoder includes at least a predictor configured to predict the first character,
each of the plurality of non-streaming decoders includes at least an attention decoder that is a decoder including an attention mechanism, and
the learning unit performs the Knowledge Distillation between the predictor and the attention decoder so that a likelihood of the first character string in which the first character predicted using the predictor is arranged in chronological order is similar to a likelihood of the second character string output using the attention decoder.

5. A voice recognition method, comprising:
acquiring a frame per unit time of a voice stream;
generating a first feature from the frame using a streaming encoder;
generating a first character from the first feature using a streaming decoder;
generating a second feature sequence from a first feature sequence obtained by joining the first feature of each of the plurality of frames using a non-streaming encoder;
generating a second character string from the second feature sequence using a plurality of non-streaming decoders; and
performing Knowledge Distillation between the streaming encoder and the non-streaming encoder on the basis of the first feature sequence and the second feature sequence.

6. A non-transient storage medium having a program stored therein, the program causing a computer to execute:
acquiring a frame per unit time of a voice stream;
generating a first feature from the frame using a streaming encoder;
generating a first character from the first feature using a streaming decoder;
generating a second feature sequence from a first feature sequence obtained by joining the first feature of each of the plurality of frames using a non-streaming encoder;
generating a second character string from the second feature sequence using a plurality of non-streaming decoders; and
performing Knowledge Distillation between the streaming encoder and the non-streaming encoder on the basis of the first feature sequence and the second feature sequence.
